(19) United States
(12) Patent Application Publication
(10) Pub. No.: US 2026/0225448 A1
(43) Pub. Date: Aug. 6, 2026

(54) INTERACTION DEVICE, TERMINAL DEVICE, INTERACTION METHOD, AND INTERACTION SYSTEM

(71) Applicant: HONDA MOTOR CO., LTD., Tokyo (JP)

(72) Inventor: Tomoaki Nakayama, Wako-shi (JP)

(21) Appl. No.: 19/444,467

(22) Filed: Jan. 9, 2026

(30) Foreign Application Priority Data
Feb. 3, 2025 (JP) 2025-016140

(51) Int. Cl. B60K 35/29

(52) U.S. Cl. CPC B60K 35/29; B60K 2360/148; B60K 2360/731

(57) ABSTRACT

An interaction device that interacts with a user by a voice or text includes: a decision unit that decides a policy for a response content to a prompt which is input by the user; a first generation unit that generates a first sentence based on the policy decided by the decision unit; a second generation unit that generates a second sentence based on the policy decided by the decision unit; and an output unit that outputs, by a voice or text, the first sentence generated by the first generation unit and the second sentence generated by the second generation unit.

### INCORPORATION BY REFERENCE

The present application claims priority under 35 U.S.C. § 119 to Japanese Patent Application No.2025-016140 filed on Feb. 3, 2025. The content of the application is incorporated herein by reference in its entirety.

### BACKGROUND OF THE INVENTION

### Field of the Invention

The present invention relates to an interaction device, a terminal device, an interaction method, and an interaction system.

### Description of the Related Art

In the related arts, techniques for interacting with a user have been known.

For example, Japanese Patent No. 6150077 discloses a voice interaction device for a vehicle that performs filler processing to fill in a “gap of silence” when a time until a response to a query from a driver is output is longer than an allowable waiting time.

However, a voice output in the filler processing of Japanese Patent No. 6150077 is a voice that is not directly relevant to the query from the driver. Therefore, in Japanese Patent No. 6150077, a voice for filling in the “gap of silence” and a voice for a query that is irrelevant in content to the voice are output in response to the query from the driver, which may cause a user to feel uncomfortable during an interaction.

An object of the present invention, which has been made in view of the above circumstances, is to make it possible to output a plurality of sentences related in content in response to a prompt, which is input by a user.

### SUMMARY OF THE INVENTION

An aspect of the present invention provides an interaction device that interacts with a user by a voice or text includes: a decision unit that decides a policy for a response content to a prompt which is input by the user; a first generation unit that generates a first sentence based on the policy decided by the decision unit; a second generation unit that generates a second sentence based on the policy decided by the decision unit; and an output unit that outputs, by a voice or text, the first sentence generated by the first generation unit and the second sentence generated by the second generation unit.

According to the aspect of the present invention, a plurality of sentences related in content can be output in response to the prompt input by the user.

### BRIEF DESCRIPTION OF THE DRAWINGS

FIG. 1 is a diagram illustrating a configuration of an interaction system;

FIG. 2 is a diagram illustrating a configuration of an interaction device;

FIG. 3 is a diagram illustrating functional units of a processor;

FIG. 4 is a flowchart illustrating an operation of the interaction device;

FIG. 5 is a diagram illustrating an example of an interaction between the interaction device and a passenger;

FIG. 6 is a diagram illustrating an example of an interaction between the interaction device and a passenger; and

FIG. 7 is a diagram illustrating an example of an interaction between the interaction device and a passenger.

### DETAILED DESCRIPTION OF THE INVENTION

### 1. Configuration of Interaction System

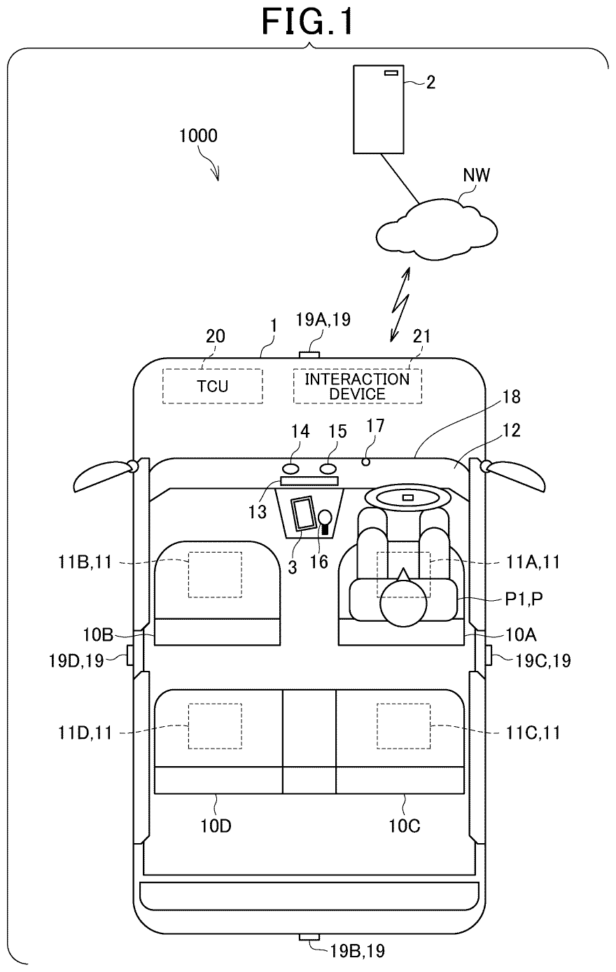

FIG. 1 is a diagram illustrating a configuration of an interaction system 1000.

The interaction system 1000 is a system that interacts with a passenger P of a vehicle 1 by a voice.

The passenger P is an example of a “user”.

The interaction system 1000 includes an interaction device 21 provided in the vehicle 1 and a traffic information server 2 connected to a network NW, which is a wide area network (WAN). The traffic information server 2 is a server device that provides traffic information indicating traffic conditions in an area including a current position of the vehicle 1. FIG. 1 illustrates a case in which a terminal device 3 used by the passenger P is mounted in an interior of the vehicle 1. The terminal device 3 includes sound output means such as a speaker and display means such as a display.

FIG. 1 illustrates a configuration of the vehicle 1. The vehicle 1 illustrated in FIG. 1 is a four-wheel vehicle. The vehicle 1 includes a driver's seat 10A, a passenger seat 10B, a rear right seat 10C, and a rear left seat 10D. In the vehicle 1 illustrated in FIG. 1, a driver is seated on the driver's seat 10A and is seated as a passenger P.

The vehicle 1 includes seating sensors 11A, 11B, 11C, and 11D that detect a weight applied to the seats. The seating sensor 11A is provided in the driver's seat 10A, the seating sensor 11B is provided in the passenger seat 10B, the seating sensor 11C is provided in the rear right seat 10C, and the seating sensor 11D is provided in the rear left seat 10D.

In the following description, the seating sensors 11A, 11B, 11C, and 11D will be referred to as a “seating sensor 11” attached with a reference number “11” unless otherwise distinguished.

The vehicle 1 includes a dashboard 12. A touch panel 13, a speaker 14, and a microphone 15 are installed on the dashboard 12. The touch panel 13 is configured in such a manner that a display panel and a touch sensor are overlapped or integrated, the display panel being configured to display characters and images, the touch sensor being configured to detect contact with the display panel. The speaker 14 outputs sound to an interior space of the vehicle 1. The microphone 15 collects sounds inside the vehicle 1. The installation positions and number of the speaker 14 and the microphone 15 are modifiable as desired.

The vehicle 1 includes a shift lever 16. The shift lever 16 is installed near the driver's seat 10A.

The vehicle 1 includes an illuminance sensor 17. The illuminance sensor 17 is installed near a windshield 18 and detects illuminance outside the vehicle 1.

The vehicle 1 includes a front camera 19A, a rear camera 19B, a right side camera 19C, and a left side camera 19D. The front camera 19A is a camera that captures images in front of the vehicle 1. The rear camera 19B is a camera that captures images behind the vehicle 1. The right side camera 19C is a camera that captures images to the right of the vehicle 1. The left side camera 19D is a camera that captures images to the left of the vehicle 1.

Hereinafter, the front camera 19A, the rear camera 19B, the right side camera 19C, and the left side camera 19D will be referred to as a “camera 19” attached with a reference number “19” unless otherwise distinguished.

The vehicle 1 includes a telematics control unit (TCU) 20. The TCU 20 is a communication device (transmitter/receiver, circuit) that communicates with devices connected to the network NW.

The vehicle 1 includes an interaction device 21. The interaction device 21 is a device that interacts with the passenger P.

### 2. Configuration of Interaction Device

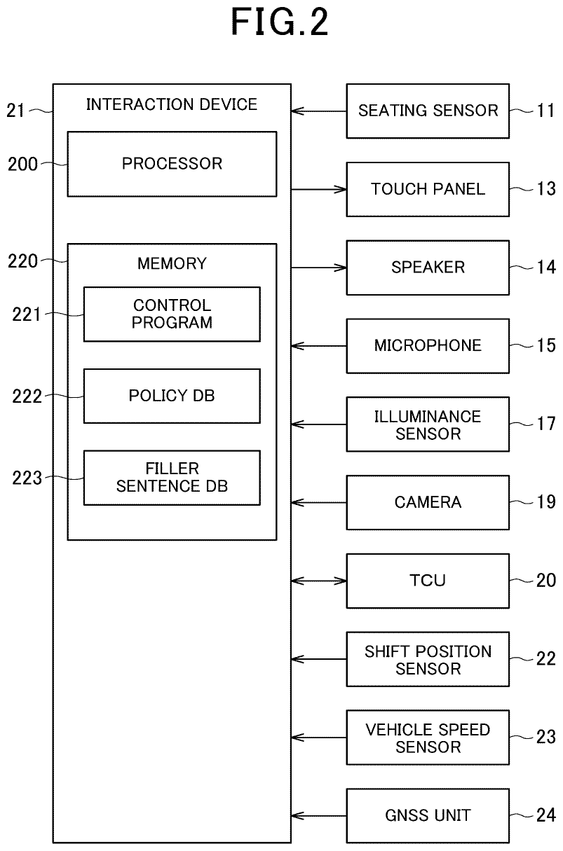

FIG. 2 is a diagram illustrating a configuration of the interaction device 21.

The interaction device 21 is connected with the seating sensor 11, the touch panel 13, the speaker 14, the microphone 15, the illuminance sensor 17, the camera 19, the TCU 20, a shift position sensor 22, a vehicle speed sensor 23, and a GNSS (Global Navigation Satellite System) unit 24 (sensor). Devices connected to the interaction device 21 are not limited to these devices, and other types of devices may be connected.

The seating sensor 11 detects a weight at a predetermined cycle, and outputs a detection value indicating the detected weight to the interaction device 21.

The touch panel 13 displays various information under the control of the interaction device 21.

The speaker 14 outputs various sounds under the control of the interaction device 21.

The microphone 15 collects sounds under the control of the interaction device 21.

The illuminance sensor 17 detects illuminance at a predetermined cycle, and outputs a detection value indicating the detected illuminance to the interaction device 21.

The camera 19 captures images under the control of the interaction device 21, and outputs the image-captured data obtained by the capturing to the interaction device 21.

The TCU 20 communicates with the devices connected to the network NW under the control of the interaction device 21.

The shift position sensor 22 detects shift positions of the shift lever 16 provided in the vehicle 1. The shift positions include, for example, P (parking) used during parking or stopping, R (reverse) used during driving in reverse, N (neutral), and D (drive) used during driving. The shift position sensor 22 outputs a detection value indicating the detected shift position to the interaction device 21.

The vehicle speed sensor 23 detects a speed of the vehicle 1. The vehicle speed sensor 23 detects a speed of the vehicle 1 at a predetermined cycle, and outputs a detection value indicating the speed of the vehicle 1 detected every detection to the interaction device 21.

The GNSS unit 24 measures a current position of the vehicle 1. The GNSS unit 24 generates position data indicating the current position of the vehicle 1, and outputs the generated position data to the interaction device 21.

The interaction device 21 incudes a processor 200 such as a CPU (Central Processing Unit) or an MPU (Micro Processor Unit), a memory 220, and an interface circuit configured to connect other devices.

The memory 220 is an example of a “storage unit”.

The memory 220 is a storage device that stores programs and data. The memory 220 stores data to be processed by a control program 221, a policy DB (database) 222, a filler sentence DB 223, and the processor 200. The memory 220 has a nonvolatile storage region. Further, the memory 220 may have a volatile storage region and constitutes a work area for the processor 200. The memory 220 is implemented by a ROM (Read Only Memory) or a RAM (Random Access Memory), for example.

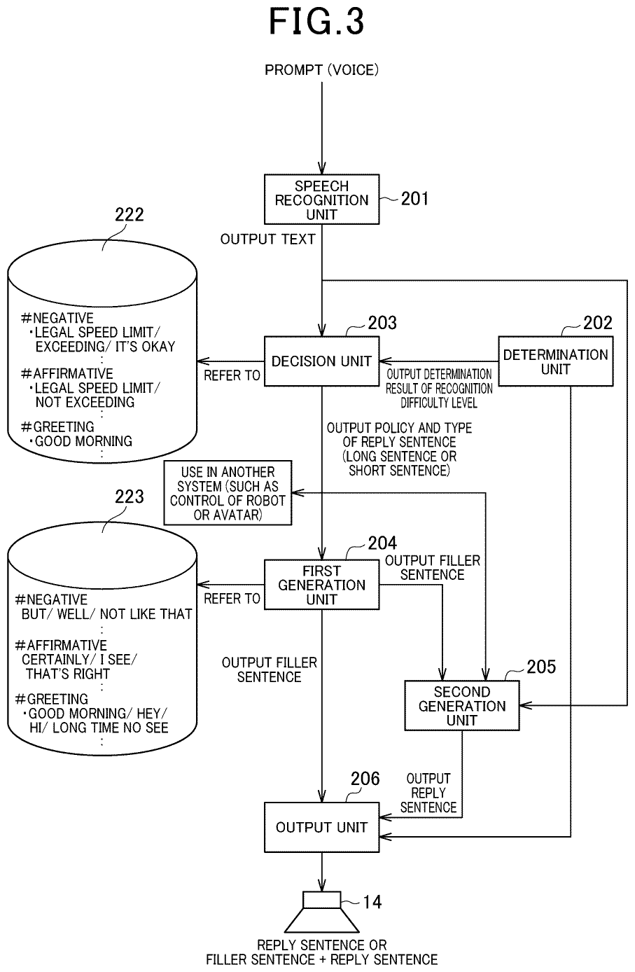

The control program 221 is a program that is read and executed by the processor 200 to cause the processor 200 to function as functional units illustrated in FIG. 3.

Here, referring to FIG. 3, the functional units of the processor 200 will be described while the policy DB 222 and the filler sentence DB 223 are described.

FIG. 3 is a diagram illustrating the functional units of the processor 200.

As illustrated in FIG. 3, the processor 200 reads and executes the control program 221 to function as a speech recognition unit 201, a determination unit 202, a decision unit 203, a first generation unit 204, a second generation unit 205, and an output unit 206.

### 2-1. Speech Recognition Unit

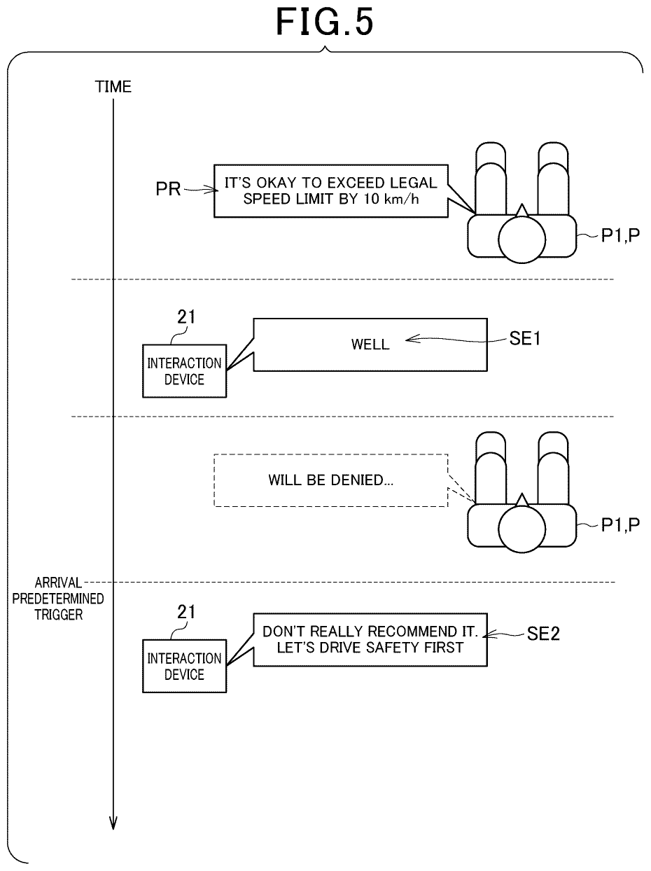

The speech recognition unit 201 performs speech recognition on a prompt PR (for example, see FIG. 5) including a content spoken by the passenger P, based on the sound collected by the microphone 15. Here, the prompt PR is input information including instructions, queries, and the like used to generate the content of the interaction. The speech recognition unit 201 converts the prompt PR of the voice into text using a speech recognition function, and outputs the converted text to the decision unit 203. In addition, the speech recognition unit 201 converts the prompt PR of the voice into text using an existing speech recognition function that refers to an acoustic model and a language model.

The speech recognition unit 201 determines whether the passenger P speaks specific words (so-called wake-up words or trigger words) that indicate the beginning of a voice instruction, and recognizes a subsequent speech as the prompt PR when wake-up words are spoken. The speech recognition unit 201 may detect a voice section of collected sounds using voice activity detection without using a wake-up word, and then recognize a speech within the voice section as a prompt PR.

The speech recognition unit 201 outputs the converted text to the decision unit 203 and the second generation unit 205.

### 2-2. Determination Unit

The determination unit 202 determines a recognition difficulty level. The recognition difficulty level indicates the degree of difficulty with which the passenger P can recognize the content of a reply sentence SE2 (hereinafter, appropriately referred to as a “reply sentence SE2”) in response to the content of the prompt PR. The determination unit 202 of the present embodiment determines the recognition difficulty level based on traffic conditions at the current position of the vehicle 1, brightness around the vehicle 1, an operation difficulty level of the passenger P with respect to the vehicle 1, and the presence or absence of a fellow passenger.

The reply sentence is an example of a “second sentence”.

It is considered that the worse the traffic conditions, the less likely the passenger P will pay attention to anything other than the traffic conditions. In other words, it is considered that the better the traffic conditions, the more likely it is that the passenger P will pay attention to anything other than the traffic conditions. Therefore, it is expected that the worse the traffic conditions, the more difficult it will be for the passenger P to recognize the content of the reply sentence SE2. Therefore, the worse the traffic conditions, the higher the recognition difficulty level that the determination unit 202 determines.

Furthermore, the darker the surroundings of the vehicle 1, the poorer the visibility outside the vehicle 1, and therefore it is considered that the passenger P is unlikely to pay attention to anything other than matters related to the driving of the vehicle 1. In other words, the brighter the surroundings of the vehicle 1, the better the visibility outside the vehicle 1, and therefore it is considered that the passenger P is likely to pay attention to anything other than matters related to the driving of the vehicle 1. Therefore, it is expected that the darker the surroundings of the vehicle 1, the more difficult it will be for the passenger P to recognize the content of the reply sentence SE2. Therefore, the darker the surroundings of the vehicle 1, the higher the recognition difficulty level that the determination unit 202 determines.

In addition, when a fellow passenger is in the vehicle, it is considered that there is a high probability that an interaction will take place with the fellow passenger, and it is considered that the passenger P is unlikely to pay attention to the reply sentence SE2. Therefore, when a fellow passenger is in the vehicle, the determination unit 202 determines the recognition difficulty level to be higher than when no fellow passenger is in the vehicle.

In addition, when the vehicle 1 is backing up or when the vehicle 1 turns right at an intersection, it is considered that the operation difficulty level of the passenger P with respect to the vehicle 1 is higher than when the vehicle 1 is stopped or when the vehicle 1 is not backing up. For this reason, the determination unit 202 determines the recognition difficulty level based on operation difficulty level of the passenger P with respect to the vehicle 1.

The determination unit 202 transmits request information for requesting the traffic information to the traffic information server 2 via the TCU 20. The request information involves the latest position data received from the GNSS unit 24. When transmitting the request information, the determination unit 202 receives traffic information from the traffic information server 2. Next, the determination unit 202 uses a traffic jam situation, a traffic regulation situation and the like involved in the received traffic information as parameters, and acquires a numerical value representing whether the traffic condition is better or worse using a predetermined algorithm. The predetermined algorithm is an algorithm that outputs a value indicating that the traffic conditions are worse as the number of traffic jams, a distance of traffic jam, or the number of traffic regulations becomes greater.

Furthermore, the determination unit 202 acquires the detection value of the illuminance sensor 17 as the degree of brightness around the vehicle 1. The determination unit 202 may acquire, as a numerical value, the degree of brightness around the vehicle 1 from the captured image indicated by the image-captured data of the camera 19.

In addition, the determination unit 202 determines whether a fellow passenger is in the vehicle based on the detection value of the seating sensor 11. When at least one of the seating sensors 11B, 11C, and 11D outputs a detection value corresponding to a seated state, the determination unit 202 determines that a fellow passenger is in the vehicle. On the other hand, when none of the seating sensors 11B, 11C, and 11D outputs a detection value corresponding to a seated state, the determination unit 202 determines that a fellow passenger is not in the vehicle.

The determination unit 202 also specifies the work content of the passenger P with respect to the vehicle 1 based on detection values from the vehicle speed sensor of the vehicle 1, a gyro-sensor of the vehicle 1, and the shift position sensor of the vehicle 1. Next, the determination unit 202 acquires an operation difficulty level corresponding to the specified work content from a database or the like.

The determination unit 202 acquires a comprehensive evaluation value using a predetermined algorithm, based on the degree of good or bad traffic conditions, the degree of brightness around the vehicle 1, the operation difficulty level of the passenger P with respect to the vehicle 1, and the presence or absence of a fellow passenger. The predetermined algorithm is an algorithm that outputs the evaluation value to be higher as the traffic conditions becomes worse, outputs the evaluation value to be higher as the brightness around the vehicle 1 becomes darker, outputs the evaluation value to be higher as the operation difficulty level becomes higher, and outputs the evaluation value to be higher when the fellow passenger is in the vehicle rather than the fellow passenger is not in the vehicle.

When the determination unit 202 acquires the comprehensive evaluation value, the determination unit 202 compares the acquired evaluation value with a threshold to determine the recognition difficulty level corresponding to the acquired evaluation value from recognition difficulty levels prepared in multiple stages. The determination unit 202 determines the recognition difficulty level to be higher as the comprehensive evaluation value becomes higher.

In the present embodiment, the recognition difficulty levels are three stages of a “low” level, a “medium” level, and a “high” level, the “low” level being lowest in the recognition difficulty level, the “medium” level being second highest in the recognition difficulty level, the “high” level being highest in the recognition difficulty level. The determination unit 202 determines that the recognition difficulty level is “low” when the comprehensive evaluation value is equal to or less than a first threshold. The determination unit 202 determines that the recognition difficulty level is “medium” when the comprehensive evaluation value is greater than the first threshold and equal to or less than a second threshold. Furthermore, the determination unit 202 determines that the recognition difficulty level is “high” when the comprehensive evaluation value is greater than the second threshold.

When determining the recognition difficulty level, the determination unit 202 outputs the determination result of the recognition difficulty level to the decision unit 203.

### 2-3. Decision Unit

The decision unit 203 decides a policy for a response content to the prompt PR (hereinafter, appropriately referred to as a “policy”) input by the passenger P. The decision unit 203 determines the policy based on the text input from the speech recognition unit 201, with reference to the policy DB 222.

The policy DB 222 is a database that stores a policy as information. The policy indicates that what kind of response content to the prompt PR is given with respect to the content of the prompt PR. The policy DB 222 stores, as information, a plurality of policies including “negative”, “affirmative”, and “greeting”.

The policy of “negative” indicates that the response content to the prompt PR is a negative content with respect to the content of the prompt PR.

The policy of “affirmative” indicates that the response content to the prompt PR is an affirmative content with respect to the content of the prompt PR.

The policy of “greeting” indicates that the response content to the prompt PR is a content to greet with respect to the content of the prompt PR.

In the policy DB 222, at least one word or a plurality of words and one or a plurality of word groups are associated with each of the policies, as information.

For example, the policy of “negative” is associated with a group of words such as “legal speed limit”, “exceeding”, and “It's okay”, a group of words such as “stop signs” , “willing to follow”, and “not”, and a group of words such as “ramen”, “salt”, and “more”.

For example, the policy of “affirmative” is associated with a group of words such as “legal speed limit” and “not exceeding”, a group of words such as “stop signs” , “willing to follow”, and “are”, and a group of words such as “ramen”, “soy sauce”, and “No. 1”.

For example, the policy of “greeting” is associated with words “good morning”, a word “hello”, words “good evening”, and a group of words such as “Hi” and “long time no see”.

The decision unit 203 extracts one word or a plurality of words from the text input from the speech recognition unit 201. The decision unit 203 extracts one word or a plurality of words from the text by referring to a dictionary in which a plurality of words are recorded, for example. The dictionary referred to in the method of this example is stored in the memory 220.

When extracting words from the text input from the speech recognition unit 201, the decision unit 203 refers to the policy DB 222 and specifies a policy corresponding to the extracted one word or a plurality of words.

For example, when the word extracted from the text is “good morning”, the decision unit 203 specifies “greeting” as the policy.

For example, when the three words of “legal speed limit”, “exceeding”, and “It's okay” are extracted from the text, the decision unit 203 specifies “negative” as the policy.

For example, when the three words of “ramen”, “soy sauce”, and “No. 1” are extracted from the text, the decision unit 203 specifies “affirmative” as the policy.

The decision unit 203 further decides the type of reply sentence SE2 to be a long sentence or a short sentence. The long sentence is a sentence longer than the short sentence and is equal to or longer than a predetermined length. In other words, the long sentence is a sentence having a predetermined number of characters or more. In addition, the short sentence is a sentence shorter than the long sentence, and is shorter than the predetermined length. In other words, the short sentence is a sentence having fewer characters than the predetermined number of characters. The predetermined number is 20 as an example, but may be 19 or less or 21 or more.

The long sentence is an example of a “sentence of a first length”. The short sentence is an example of a “sentence of a second length”.

The decision unit 203 decides the type of reply sentence SE2 to be a long sentence or a short sentence, based on the determination result of the recognition difficulty level input from the determination unit 202. For example, when the determination result of the recognition difficulty level indicates “high”, the decision unit 203 decides the type of reply sentence SE2 to be a long sentence. For example, when the determination result of the recognition difficulty level indicates “low” or “medium”, the decision unit 203 decides the type of reply sentence SE2 to be a short sentence.

Furthermore, when the words extracted from the text input from the speech recognition unit 201 include words related to driving, the decision unit 203 decides the type of reply sentence SE2 to be a long sentence. On the other hand, when the words extracted from the text input from the speech recognition unit 201 do not include words related to driving, the decision unit 203 decides the type of reply sentence SE2 to be a short sentence. Here, the words related to driving will be described. Examples of the words related to driving include legal speed limit, stop signs, traffic lights, expressways, oncoming vehicles, and pedestrians are set in advance.

When deciding the policy, the decision unit 203 outputs the decided policy to the first generation unit 204 and the second generation unit 205. Furthermore, when deciding the type of reply sentence SE2, the decision unit 203 outputs the decided type of reply sentence SE2 to the first generation unit 204 and the second generation unit 205.

The decision unit 203 may decide the policy and the type of reply sentence SE2 as follows.

In this case, instructions are described in the policy DB 222, the instructions including “always deny claims that violate the law”, “respond in a long sentence to questions about interests and preferences without denying them”, and “respond in a long sentence to questions about driving”.

The decision unit 203 inputs the text input from the speech recognition unit 201 and the information described in the policy DB 222 to a language model such as LLM (Large Language Models), and obtains the policy and the type of reply sentence SE2 from the language model, thereby deciding the policy and the type of reply sentence SE2. For example, when the word extracted from the text input by the speech recognition unit 201 is “good morning”, the decision unit 203 inputs the word “good morning” and the information described in the policy DB 222 to the language model. When the language model outputs “long sentence and affirmative”, the decision unit 203 decides “greeting” as the policy and decides “long sentence” as the type of reply sentence SE2. In addition, when the language model outputs “greeting, long sentence”, the decision unit 203 decides “greeting” as the policy and determines “long sentence” as the type of reply sentence SE2.

### 2-4. First Generation Unit

The first generation unit 204 determines whether to generate a filler sentence SE1 indicating a filler or an interjection. The first generation unit 204 determines not to generate the filler sentence SE1 when the type of reply sentence SE2 indicates a short sentence, and determines to generate the filler sentence SE1 when the type of reply sentence SE2 indicates a long sentence.

The filler sentence SE1 is an example of a “first sentence”.

When determining to generate the filler sentence SE1, the first generation unit 204 generates the filler sentence SE1 based on the policy input from the decision unit 203. The first generation unit 204 extracts the filler sentence SE1 from the filler sentence DB 223, thereby generating the filler sentence SE1.

The filler sentence DB 223 is a database that stores the filler sentence SE1 as information. In the filler sentence DB 223, each of the policies is associated with one or a plurality of filler sentences SE1.

For example, in the filler sentence DB 223, filler sentences SE1 such as “but”, “well”, and “not like that” are associated with the policy of “negative”.

For example, in the filler sentence DB 223, filler sentences SE1 such as “certainly”, “I see”, and “that's right” are associated with the policy of “affirmative”.

For example, in the filler sentence DB 223, filler sentences SE1 such as “Hey”, “Hi”, and “long time no see” are associated with the policy of “greeting”.

The first generation unit 204 acquires the filler sentence SE1 corresponding to the policy decided by the decision unit 203 from the filler sentence DB 223, thereby generating the filler sentence SE1.

For example, when the policy decided by the decision unit 203 is “negative”, the first generation unit 204 acquires the filler sentence SE1 of “but” from the filler sentence DB 223.

For example, when the policy decided by the decision unit 203 is “affirmative”, the first generation unit 204 acquires the filler sentence SE1 of “that's right” from the filler sentence DB 223.

For example, when the policy decided by the decision unit 203 is “greeting”, the first generation unit 204 acquires the filler sentence SE1 of “Hi” from the filler sentence DB 223.

When generating the filler sentence SE1, the first generation unit 204 outputs the generated filler sentence SE1 to the second generation unit 205 and the output unit 206.

In addition, the first generation unit 204 may generate the filler sentence SE1 as follows. The first generation unit 204 may input the text acquired from the filler sentence DB 223 to the language model such as an LLM, and acquire a filler sentence SE1 of expressions determined to be appropriate by the language model, thereby generating the filler sentence SE1.

### 2-5. Second Generation Unit

When the first generation unit 204 outputs the filler sentence SE1, the second generation unit 205 generates a reply sentence SE2 based on the text input from the speech recognition unit 201, the policy and the type of reply sentence SE2 input from the decision unit 203, and the filler sentence SE1 input from the first generation unit 204.

On the other hand, when the first generation unit 204 does not output the filler sentence SE1, the second generation unit 205 generates a reply sentence SE2 based on the text input from the speech recognition unit 201 and the policy and the type of reply sentence SE2 input from the decision unit 203.

For example, the second generation unit 205 generates the reply sentence SE2 using the language model such as an LLM. In this example, the storage device (the memory 220 or the database connected to the network NW), to which the processor 200 is accessible, stores a machine-learned model that outputs the reply sentence SE2 in response to the prompt PR input by the passenger P, interaction conditions such as topics, the policy, the type of reply sentence SE2, and the input of the filler sentence SE1.

Such a model outputs a negative reply sentence SE2 with respect to the content of the prompt PR input by the passenger P when the policy of “negative” is input, outputs an affirmative reply sentence SE2 with respect to the content of the prompt PR input by the passenger P when the policy of “affirmative” is input, and outputs a reply sentence SE2 to greet with respect to the content of the prompt PR input by the passenger P when the policy of “greeting” is input.

Furthermore, when the filler sentence SE1 is input, such a model outputs a reply sentence SE2 not including the input filler sentence SE1 at the beginning part.

In addition, such a model outputs a reply sentence SE2 corresponding to the type of the input reply sentence SE2. In other words, such a model outputs a reply sentence SE2 formed of a predetermined number of characters or more when the type of the input reply sentence SE2 is a long sentence, and outputs a reply sentence SE2 formed of characters fewer than the predetermined number of characters when the type of the input reply sentence SE2 is a short sentence.

The generation of the reply sentence SE2 is not limited to the generation using the language model such as the LLM. For example, the reply sentence SE2 may be generated based on a fixed form sentence or a rule base. During the generation based on the fixed form sentence or the rule base, the second generation unit 205 generates a negative reply sentence SE2 when the policy is “negative”, generates an affirmative reply sentence SE2 when the policy is “affirmative”, and generates a reply sentence SE2 to greet when the policy is “greeting”. In this case, the second generation unit 205 generates a reply sentence SE2 not including the filler sentence SE1 at the beginning part. In this case, the second generation unit 205 generates a reply sentence SE2 formed of a predetermined number of characters or more when the type of the reply sentence SE2 is a long sentence, and generates a reply sentence SE2 formed of characters fewer than the predetermined number of characters when the type of the reply sentence SE2 is a short sentence.

When generating the reply sentence SE2, the second generation unit 205 outputs the generated reply sentence SE2 to the output unit 206.

### 2-6. Output Unit

When not receiving the filler sentence SE1 from the first generation unit 204 but receiving the reply sentence SE2 from the second generation unit 205, the output unit 206 outputs the reply sentence SE2 through the speaker 14.

Furthermore, when receiving the filler sentence SE1 from the first generation unit 204 but receiving the reply sentence SE2 from the second generation unit 205, the output unit 206 outputs the filler sentence SE1 and the reply sentence SE2 through the speaker 14. In this case, the output unit 206 outputs the filler sentence SE1 earlier than the reply sentence SE2. The output unit 206 outputs the reply sentence SE2 when a predetermined trigger arrives after the filler sentence SE1 is output. Examples of the predetermined trigger include the end of the output of the filler sentence SE1, the lapse of a predetermined time (for example, 2 seconds) from the output of the filler sentence SE1, the stop of the vehicle 1 after the output of the filler sentence SE1, and the recognition difficulty level determined by the determination unit 202 to be a predetermined level (“low” or “medium”) or less. The output unit 206 determines that the vehicle 1 has stopped, based on the detection value of the shift position sensor 22 and the detection value of the vehicle speed sensor 23.

### 3. Operation

Next, an operation of the interaction device 21 according to the present embodiment will be described.

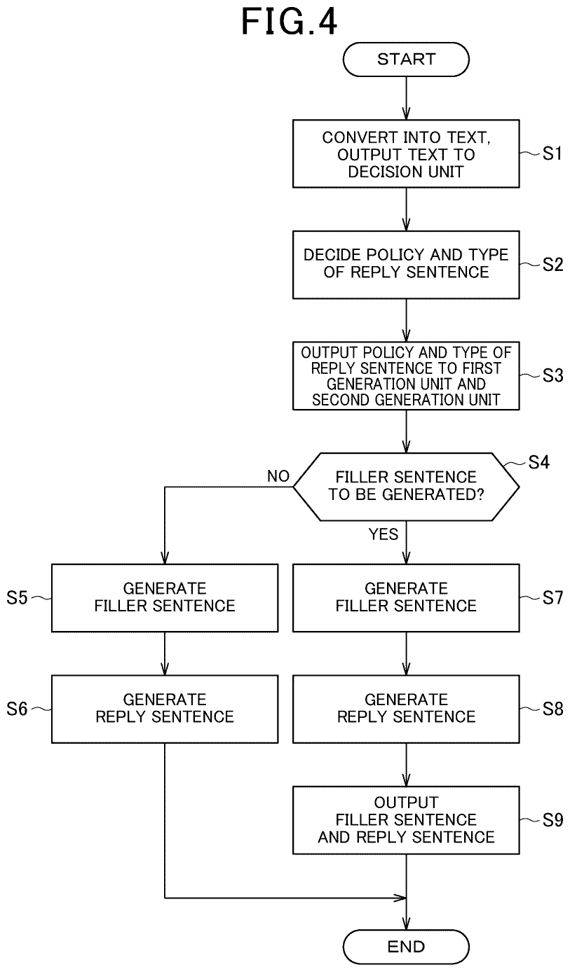

FIG. 4 is a flowchart illustrating the operation of the interaction device 21.

When the passenger P inputs a prompt PR by a voice, the speech recognition unit 201 converts the prompt PR into text, and outputs the converted text to the decision unit 203 (step S1).

The decision unit 203 refers to the policy DB 222, and decides a policy and a type of reply sentence SE2 based on the text input from the speech recognition unit 201 and the determination result of the recognition difficulty level input from the determination unit 202 (step S2).

The decision unit 203 outputs the policy and the type of reply sentence SE2, which are decided in step S2, to the first generation unit 204 and the second generation unit 205 (step S3).

Next, the first generation unit 204 determines whether to generate a filler sentence SE1 (step S4).

When the first generation unit 204 determines not to generate the filler sentence SE1 (step S4: NO), the second generation unit 205 generates a reply sentence SE2 (step S5). Next, the output unit 206 outputs the reply sentence SE2 generated in step S5 (step S6).

On the other hand, when determining to generate the filler sentence SE1 (step S4: YES), the first generation unit 204 refers to the filler sentence DB 223 and generates the filler sentence SE1 (step S7).

Next, the second generation unit 205 generates a reply sentence SE2 using the text input from the speech recognition unit 201, the policy and the type of reply sentence SE2 generated in step S3, and the filler sentence SE1 generated in step S7 (step S8).

Next, the output unit 206 outputs the filler sentence SE1 generated in step S7 and the reply sentence SE2 generated in step S8 (step S9).

A specific example of an interaction between the interaction device 21 and the passenger P will be described below with reference to FIGS. 5, 6 and 7.

FIG. 5 is a diagram illustrating an example of an interaction between the interaction device 21 and the passenger P.

FIG. 5 illustrates a case in which the recognition difficulty level is not “high”.

FIG. 5 illustrates a case in which the passenger P inputs a prompt PR, “It's okay to exceed the legal speed limit by 10 km/h” to the interaction device 21 by a voice. The prompt PR involves words related to driving.

In FIG. 5, the interaction device 21 decides the policy to be “negative”, and decides the type of reply sentence SE2 to be a long sentence. Therefore, in the example of FIG. 5, the interaction device 21 outputs the filler sentence SE1 “well”. Thus, the passenger P can predict that the input prompt PR will be denied, before the reply sentence SE2 is output.

In the example of FIG. 5, the interaction device 21 outputs the filler sentence SE1 “well” and then outputs a reply sentence SE2, “Don't really recommend it. Let's drive safety first” when a predetermined trigger arrives. Thus, the passenger P can recognize that the input prompt PR has been denied. In the example of FIG. 5, the passenger P can recognize to drive in safety first. Furthermore, since the filler sentence SE1, which has a content related to the content of the reply sentence SE2, is output earlier than the reply sentence SE2, the passenger P can recognize the content of the reply sentence SE2 without uncomfortable feeling.

As described above, the beginning part of the reply sentence SE2 does not include the filler sentence SE1. For this reason, in the case of FIG. 5, the interaction device 21 does not output the reply sentence SE2, “Well, don't really recommend it. Let's drive safety first” after the filler sentence SE1 “well”. This prevents the passenger P from uncomfortable feeling when the filler sentence SE1 is output several times.

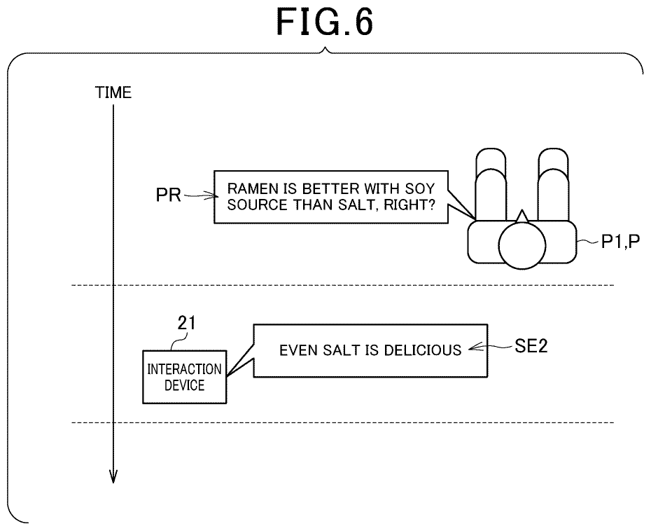

FIG. 6 is a diagram illustrating an example of an interaction between the interaction device 21 and the passenger P.

FIG. 6 illustrates a case in which the recognition difficulty level is not “high”.

FIG. 6 illustrates a case in which the passenger P inputs a prompt PR, “Ramen is better with soy sauce than salt, right?” by a voice. The prompt PR does not involve words related to driving.

In FIG. 6, the interaction device 21 decides the policy to be “negative”, and decides the type of reply sentence SE2 to be a short sentence. Therefore, in the example of FIG. 6, the interaction device 21 outputs the reply sentence SE2 “Even salt is delicious”, without outputting the filler sentence SE1.

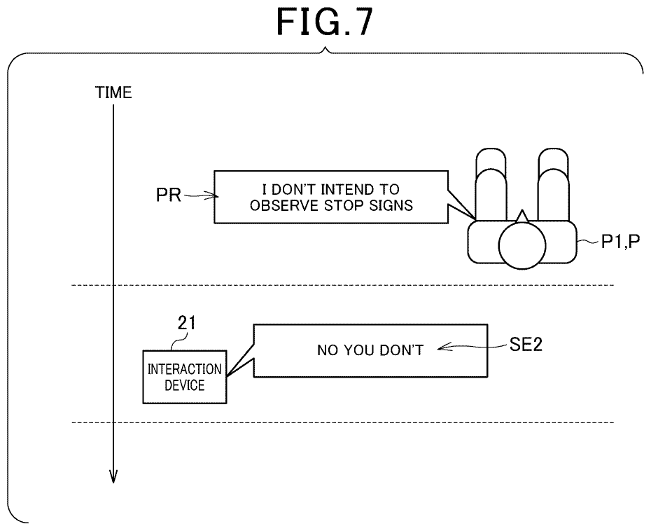

FIG. 7 is a diagram illustrating an example of an interaction between the interaction device 21 and the passenger P.

FIG. 7 illustrates a case in which the recognition difficulty level is “high”.

FIG. 7 illustrates a case in which the passenger P inputs a prompt PR, “I don't intend to observe stop signs” by a voice. The prompt PR involves words related to driving.

In the example of FIG. 7, the interaction device 21 decides the policy to be “negative”, and decides the type of reply sentence SE2 to be a short sentence. Therefore, in the example of FIG. 7, the interaction device 21 outputs the reply sentence SE2 “no you don't”, without outputting the filler sentence SE1.

### 4. Other Embodiments

The above-described embodiment is merely one aspect, and can be modified arbitrarily and be applicable.

In the above-described embodiment, a case has been described in which the processor 200 of the interaction device 21 functions as the speech recognition unit 201, the determination unit 202, the decision unit 203, the first generation unit 204, the second generation unit 205, and the output unit 206. In other embodiments, a processor of the server device connected to the network NW may function as at least one of the speech recognition unit 201, the determination unit 202, the decision unit 203, the first generation unit 204, and the second generation unit 205. When the processor of the server device connected to the network NW functions as the speech recognition unit 201, the server device acquires the prompt PR input from the vehicle 1 by the passenger P. When the processor of the server device connected to the network NW functions as the determination unit 202, the server device acquires the presence or absence of a fellow passenger and the brightness outside the vehicle 1 from the vehicle 1. When the processor of the server device connected to the network NW functions as the decision unit 203, the server device stores the policy DB 222. When the processor of the server device connected to the network NW functions as the first generation unit 204, the server device stores the filler sentence DB 223 and transmits the generated filler sentence SE1 to the vehicle 1. In addition, when the processor of the server device connected to the network NW functions as the second generation unit 205, the server device transmits the generated reply sentence SE2 to the vehicle 1.

In other embodiments, the terminal device 3 may interact with the passenger P instead of or together with the interaction device 21. In other embodiments, the processor of the terminal device 3 functions as the speech recognition unit 201, the determination unit 202, the decision unit 203, the first generation unit 204, the second generation unit 205, and the output unit 206. In other embodiments, the memory of the terminal device 3 stores the policy DB 222 and the filler sentence DB 223. Among the functional units of the processor of the terminal device 3, at least one of the speech recognition unit 201, the determination unit 202, the decision unit 203, the first generation unit 204, and the second generation unit 205 may be executed as a function of the processor of the server device connected to the network NW.

In the above-described embodiment, the interaction between the passenger P and the interaction device 21 or the terminal device 3 is performed via voice. In other embodiments, such an interaction may be performed via text, or may be performed by conversion of gestures or sign language into text. In other embodiments, the passenger P input the prompt PR of text to the interaction device 21 or the terminal device 3. In other embodiments, the input prompt PR of text is output to the decision unit 203 without passing through the speech recognition unit 201. In other embodiments, the output unit 206 outputs the reply sentence SE2, or the filler sentence SE1 and the reply sentence SE2 by displaying information. In other embodiments, the output unit 206 may output the reply sentence SE2, or the filler sentence SE1 and the reply sentence SE2 by outputting sounds. In other embodiments, text corresponding to a gesture is set in advance, the processor 200 acquires the movement of the passenger P using a sensor such as a camera (an in-vehicle camera such as a driver monitoring camera), and the text corresponding to the gesture obtained from the acquired movement is input to the decision unit 203. In other embodiments, the processor 200 acquires the movement of the passenger P using a sensor such as a camera, and the movement acquired by the processor 200 is input to an image recognition AI or a visual language model, whereby text of a content indicated by the gesture is generated, and the generated text is input to the decision unit 203.

In other embodiments, the output unit 206 may change an output mode of the filler sentence SE1 and the reply sentence SE2 based on the information related to the passenger P or settings made by the passenger P. Examples of the information related to the passenger P may include the age of the passenger P and a gender of the passenger P.

For example, when the age of the passenger P corresponds to that of a child, the output unit 206 outputs the filler sentence SE1 and the reply sentence SE2 in a voice of a child or a character.

For example, when the age of the passenger P corresponds to that of an adult, the output unit 206 outputs the filler sentence SE1 and the reply sentence SE2 in a calm voice of an adult.

For example, when the gender of the passenger P is male, the output unit 206 outputs the filler sentence SE1 and the reply sentence SE2 in a female voice.

For example, when the gender of the passenger P is female, the output unit 206 outputs the filler sentence SE1 and the reply sentence SE2 in a male or female voice.

For example, when the age of the passenger P corresponds to that of a child, the output unit 206 outputs the filler sentence SE1 and the reply sentence SE2 in a tone of a child or a character.

For example, when the age of the passenger P corresponds to that of an adult, the output unit 206 outputs the filler sentence SE1 and the reply sentence SE2 in a tone of an adult.

For example, when the passenger P has set a preferred tone or color of voice, the output unit 206 outputs the filler sentence SE1 and the reply sentence SE2 in the tone or color of voice set by the passenger P.

The information related to the passenger P and the information set by the passenger P are stored in the storage device (for example, the memory 220 or the database connected to the network NW) accessible by the output unit 206.

In other embodiments, the first generation unit 204 may decide the type of filler sentence SE1 based on the information related to the passenger P and the setting made by the passenger P.

For example, when the age of the passenger P corresponds to that of a child, the first generation unit 204 generates a filler sentence SE1 that can be used by children but not used by adults.

For example, when the age of the passenger P corresponds to that of an adult, the first generation unit 204 generates a filler sentence SE1 that can be generally used by adults but not generally used by children.

For example, when the passenger P has set a preferred filler sentence SE1 for each policy, the first generation unit 204 generates a filler sentence SE1 set by the passenger P.

In other embodiments, the output unit 206 may output the filler sentence SE1 and the reply sentence SE2 in different modes based on the policy decided by the decision unit 203.

For example, when the policy decided by the decision unit 203 is “negative”, the output unit 206 outputs the filler sentence SE1 in a voice of a child, and outputs the reply sentence SE2 in a voice of an adult.

For example, when the policy decided by the decision unit 203 is “negative”, the output unit 206 outputs the filler sentence SE1 in a color of voice that imparts a frightening emotion, and outputs the reply sentence SE2 in a color of voice that imparts a calm emotion. In this example, the filler sentence SE1 attracts the attention of the passenger P, and the reply sentence SE2 is output in a calm color of voice, whereby the content of the reply sentence SE2 can be accurately recognized.

For example, when the policy decided by the decision unit 203 is “affirmative”, the output unit 206 outputs the filler sentence SE1 in a bright voice, and outputs the reply sentence SE2 in a brighter voice. The bright voice is a voice that allows the listener to imagine the speaker smiling and that is not too high-toned.

For example, when the policy decided by the decision unit 203 is “greeting”, the output unit 206 outputs the filler sentence SE1 in a bright voice, and outputs the reply sentence SE2 in a calm voice.

In the above-described embodiment, the filler sentence SE1 is exemplified as the “first sentence” and the reply sentence SE2 is exemplified as the “second sentence”. However, the “first sentence” is not limited to the filler sentence SE1, and the “second sentence” is not limited to the reply sentence SE2. For example, when a plurality of filler sentences SE1 are output before the reply sentence SE2 to the prompt PR is output, the “first sentence” may be any filler sentence SE1, and the “second sentence” may be a filler sentence SE1 different from the any filler sentence SE1. For example, when a plurality of reply sentences SE2 are output with respect to the content of the prompt PR, the “first sentence” may be any reply sentence SE2, and the “second sentence” may be a reply sentence SE2 different from the any reply sentence SE2.

In other embodiment, a robot or an avatar may perform a head shaking action or a change in facial expression according to the policy. In this case, the policy decided by the decision unit 203 is output to a device that controls the robot or avatar. For example, when the policy is “negative”, the robot or avatar may shake its head or have a frowning expression. For example, when the policy is “affirmative”, the robot or avatar may nod its head or have a pleased expression. Furthermore, the robot or avatar may act in conjunction with or before the speech of the filler sentence SE1 and the reply sentence SE2. Thus, a nonverbal expression is output before a verbal expression, whereby the user (for example, the passenger P in the above-described embodiment) can predict the content of the verbal expression. Alternatively, a matched verbal expression and nonverbal expression are simultaneously output to facilitate understanding of a speech intention of the user.

In the above-described embodiment, the recognition difficulty level is determined based on the traffic conditions at the current position of the vehicle 1, the brightness around the vehicle 1, and the presence or absence of a fellow passenger. In other embodiments, the recognition difficulty level may be determined based on at least one of the traffic conditions at the current position of the vehicle 1, the brightness around the vehicle 1, the operation difficulty level of the passenger P with respect to the vehicle 1, and the presence or absence of a fellow passenger. In other embodiments, the recognition difficulty level may be determined based on factors other than the traffic conditions at the current position of the vehicle 1, the brightness around the vehicle 1, and the presence or absence of a fellow passenger. For example, in other embodiments, the recognition difficulty level may be determined based on biometric data of the passenger P or operation data of the vehicle 1 (data on amount of accelerator or brake depression and steering operation). When the traffic conditions are not taken into consideration in the determination of the recognition difficulty level, the interaction system 1000 may not include the traffic information server. In other embodiments to be described below, it will be described that the “interaction system” and the “interaction device” can be applied to devices other than the vehicle 1, but the recognition difficulty level may be determined based on an operation difficulty level of the user (the person who interacts with the interaction system) in other embodiments to be described below. In this case, the operation difficulty level is decided based on whether the user is folding laundry or handling a kitchen knife, for example.

In the above-described embodiment, the recognition difficulty level is determined to be one of three levels. In other embodiments, the recognition difficulty level may be determined to be any one of N levels (N being an integer of 2 or less or an integer of 4 or more).

In the above-described embodiment, the policy DB 222 and the filler sentence DB 223 are stored in the memory 220. In other embodiments, at least one of the policy DB 222 and the filler sentence DB 223 may be stored in the storage device accessible by the processor 200. An example of the storage device includes a device connected to the network NW.

In the above-described embodiment, the “user” is exemplified as the passenger P of the vehicle 1. However, when the “interaction device” is a device mounted on a moving body other than the vehicle 1, the “user” may be a user of the moving body.

In the above-described embodiment, the “terminal device” is exemplified as a terminal device used by the passenger P. However, “terminal device” may also be a home appliance such as a smart speaker or a smart TV.

In the above-described embodiment, the “interaction system” is exemplified as a system mounted on the vehicle 1. However, the “interaction system” is not limited to the system mounted on the vehicle 1. For example, the “interaction system” may be a system applied inside a house, or may be a system applied to a moving body other than the vehicle 1, or to an object other than the moving body. For example, the “interaction system” may be a monitoring robot or an AI speaker that can communicate inside a house.

The processor 200 may be composed of a plurality of processors, or may be composed of a single processor. The processor 200 may be hardware programmed to implement the above-described functional units. In this case, the processor 200 is composed of, for example, an ASIC (Application Specific Integrated Circuit) or an FPGA (Field Programmable Gate Array).

Moreover, the configuration of respective components of the interaction device 21 illustrated in FIG. 2 is an example, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, for example, the step units of the operations illustrated in FIG. 4 are divided according to the main processing contents, and the present invention is not limited by the manner in which the processing units are divided or the names of the processing units. Depending on the processing contents, the processing may be divided into more step units. Further, one step unit may be divided so as to include more processing. In addition, the order of the steps may be modified as appropriate within the scope of the present invention.

Furthermore, when the interaction method of using the above-described interaction device 21 is to be implemented using the processor 200, the program to be executed by the processor 200 can be composed of a mode of recording medium or a mode of transmission medium that transmits the program. In other words, the control program 221 can also be implemented in a state where the control program 221 is recorded on a portable information recording medium. Examples of the information recording medium may include a magnetic recording medium such as a hard disk, an optical recording medium such as a CD, and semiconductor memory devices such as a USB (Universal Serial Bus) memory and an SSD (Solid State Drive), but other recording media can also be used.

### 5. Configuration Supported by Embodiment

The above-described embodiment supports the following configurations.

### (Configuration 1)

An interaction device that interacts with a user by a voice or text, the interaction device including: a decision unit that decides a policy for a response content to a prompt which is input by the user; a first generation unit that generates a first sentence based on the policy decided by the decision unit; a second generation unit that generates a second sentence based on the policy decided by the decision unit; and an output unit that outputs, by a voice or text, the first sentence generated by the first generation unit and the second sentence generated by the second generation unit.

According to the interaction device of Configuration 1, the first sentence and the second sentence are generated based on a common policy, and thus it is possible to generate the first sentence and the second sentence which are related in content. Therefore, it is possible to output a plurality of sentences, which are related in content, in response to the prompt input by the user. Furthermore, since the plurality of sentences, which are related in content, can be output, it is possible to prevent the user from uncomfortable feeling during an interaction.

### (Configuration 2)

In the interaction device of Configuration 1, the first sentence is a filler sentence indicating a filler or an interjection, the second sentence is a reply sentence to a content of the prompt, and the output unit outputs the first sentence earlier than the second sentence.

According to the interaction device of Configuration 2, it is possible to generate the filler sentence and the reply sentence that are related in content. Therefore, it is possible to output the filler sentence and the reply sentence, which are related in content, in response to the prompt input by the user. Furthermore, since the filler sentence is output first, it is possible to prevent the user from unpleasant feeling or uncomfortable feeling about gaps of silence that occur during an interaction.

### (Configuration 3)

In the interaction device of Configuration 1 or 2, the first generation unit refers to a corresponding relation between the policy and the first sentence in a storage unit that stores the first sentence according to the policy, and generates the first sentence corresponding to the policy.

According to the interaction device of Configuration 3, since the first sentence corresponding to the policy can be generated, the first sentence can be generated according to the policy. Therefore, it is possible to output a sentence according to the policy of the response content of the prompt.

### (Configuration 4)

In the interaction device of any one of Configurations 1 to 3, the second generation unit generates the second sentence not including the first sentence, which is generated by the first generation unit, at a beginning part.

According to the interaction device of Configuration 4, when the first sentence and the second sentence are output, the first sentence can be prevented from being output continuously. Therefore, the same content can be prevented from being output continuously in response to the prompt input by the user. Furthermore, since the same content can be prevented from being output continuously, it is possible to prevent the user from uncomfortable feeling during an interaction.

### (Configuration 5)

In the interaction device of any one of Configurations 1 to 4, the decision unit decides a type of the second sentence to be a sentence of a first length indicating a predetermined length or longer or to be a sentence of a second length shorter than the predetermined length, and the first generation unit determines whether to generate the first sentence based on the type of the second sentence decided by the decision unit, and generates the first sentence when determining to generate the first sentence.

According to the interaction device of Configuration 5, since it does not take much time to generate the second sentence when the length of the second sentence is short, processing can be executed such that the first sentence is not generated when the length of the second sentence is short. Therefore, it is possible to reduce a processing load required for outputting in response to the prompt.

### (Configuration 6)

In the interaction device of Configuration 5, the decision unit decides a length of the second sentence based on the content of the prompt.

According to the interaction device of Configuration 6, the first sentence can be output or not output depending on the content of the prompt, and this makes it possible to avoid an interaction in which the first sentence is indiscriminately output.

### (Configuration 7)

In the interaction device of Configuration 5 or 6, the interaction device further includes a determination unit that determines a recognition difficulty level indicating a degree of difficulty with which the user is recognizable a content of the second sentence, and the decision unit decides a length of the second sentence based on the recognition difficulty level determined by the determination unit.

According to the interaction device of Configuration 7, the higher the recognition difficulty level, the more difficult it is to recognize the content of the second sentence, whereby it is possible to output a sentence whose content is easy to recognize according to the recognition difficulty level by deciding the length of the second sentence according to the recognition difficulty level.

### (Configuration 8)

In the interaction device of Configuration 7, the output unit changes a timing for outputting at least one of the first sentence and the second sentence based on the recognition difficulty level determined by the determination unit.

According to the interaction device of Configuration 8, it is possible to increase the possibility that the content of the output sentence will be recognized by changing the output timing of the sentence based on the recognition difficulty level.

### (Configuration 9)

In the interaction device of any one of Configurations 1 to 8, the output unit changes an output mode of the first sentence and the second sentence based on information related to the user or setting made by the user.

According to the interaction device of Configuration 9, it is possible to increase the acceptability of the content of the output sentence by changing the output mode of the first sentence and the second sentence based on the information related to the user or the setting made by the user.

### (Configuration 10)

In the interaction device of any one of Configurations 1 to 9, the output unit outputs, in different modes, the first sentence and the second sentence based on the policy.

According to the interaction device of Configuration 10, it is possible to increase the acceptability of the content of the output sentence by outputting the first sentence and the second sentence in the different modes based on the policy instead of the same mode.

### (Configuration 11)

A terminal device that interacts with a user by a voice or text, the terminal device including: a decision unit that decides a policy for a response content to a prompt which is input by the user; a first generation unit that generates a first sentence based on the policy decided by the decision unit; a second generation unit that generates a second sentence based on the policy decided by the decision unit; and an output unit that outputs, by a voice or text, the first sentence generated by the first generation unit and the second sentence generated by the second generation unit.

The interaction method of Configuration 11 has the same effect as the interaction device of Configuration 1.

### (Configuration 12)

An interaction method of using a processor to interact with a user by a voice or text, the processor being configured to: decide a policy for a response content to a prompt which is input by the user; generate a first sentence based on the policy decided; generate a second sentence based on the policy decided; and output, by a voice or text, the first sentence generated and the second sentence generated.

The interaction method of Configuration 12 has the same effect as the interaction device of Configuration 1.

### (Configuration 13)

An interaction system that interacts with a user by a voice or text, the interaction system including: a decision unit that decides a policy for a response content to a prompt which is input by the user; a first generation unit that generates a first sentence based on the policy decided by the decision unit; a second generation unit that generates a second sentence based on the policy decided by the decision unit; and an output unit that outputs, by a voice or text, the first sentence generated by the first generation unit and the second sentence generated by the second generation unit.

The interaction system of Configuration 13 has the same effect as the interaction device of Configuration 1.

### REFERENCE SIGNS LIST

1 vehicle
2 traffic information server
3 terminal device
10A driver's seat
10B passenger seat
10C rear right seat
10D rear left seat
11, 11A to 11D seating sensor
12 dashboard
13 touch panel
14 speaker
15 microphone
16 shift lever
17 illuminance sensor
18 windshield
19 camera
19A front camera
19B rear camera
19C right side camera
19D left side camera
20 TCU
21 interaction device
22 shift position sensor
23 vehicle speed sensor
24 GNSS unit
200 processor
201 speech recognition unit
202 determination unit
203 decision unit
204 first generation unit
205 second generation unit
206 output unit
220 memory (storage unit)
221 control program
222 policy DB
223 filler sentence DB
1000 interaction system
NW network
P passenger (user)
PR prompt
SE1 filler sentence (first sentence)
SE2 reply sentence (second sentence)

1. An interaction device that interacts with a user by a voice or text, the interaction device comprising:
a decision unit that decides a policy for a response content to a prompt which is input by the user;
a first generation unit that generates a first sentence based on the policy decided by the decision unit;
a second generation unit that generates a second sentence based on the policy decided by the decision unit; and
an output unit that outputs, by a voice or text, the first sentence generated by the first generation unit and the second sentence generated by the second generation unit.

2. The interaction device according to claim 1, wherein
the first sentence is a filler sentence indicating a filler or an interjection,
the second sentence is a reply sentence to a content of the prompt, and
the output unit outputs the first sentence earlier than the second sentence.

3. The interaction device according to claim 1, wherein
the first generation unit refers to a corresponding relation between the policy and the first sentence in a storage unit that stores the first sentence according to the policy, and generates the first sentence corresponding to the policy.

4. The interaction device according to claim 1, wherein
the second generation unit generates the second sentence not including the first sentence, which is generated by the first generation unit, at a beginning part.

5. The interaction device according to claim 1, wherein
the decision unit decides a type of the second sentence to be a sentence of a first length indicating a predetermined length or longer or to be a sentence of a second length shorter than the predetermined length, and
the first generation unit determines whether to generate the first sentence based on the type of the second sentence decided by the decision unit, and generates the first sentence when determining to generate the first sentence.

6. The interaction device according to claim 5, wherein
the decision unit decides a length of the second sentence based on the content of the prompt.

7. The interaction device according to claim 5, further comprising:
a determination unit that determines a recognition difficulty level indicating a degree of difficulty with which the user is recognizable a content of the second sentence, wherein
the decision unit decides a length of the second sentence based on the recognition difficulty level determined by the determination unit.

8. The interaction device according to claim 7, wherein
the output unit changes a timing for outputting at least one of the first sentence and the second sentence based on the recognition difficulty level determined by the determination unit.

9. The interaction device according to claim 1, wherein
the output unit changes an output mode of the first sentence and the second sentence based on information related to the user or setting made by the user.

10. The interaction device according to claim 1, wherein
the output unit outputs, in different modes, the first sentence and the second sentence based on the policy.

11. A terminal device that interacts with a user by a voice or text, the terminal device comprising:
a decision unit that decides a policy for a response content to a prompt which is input by the user;
a first generation unit that generates a first sentence based on the policy decided by the decision unit;
a second generation unit that generates a second sentence based on the policy decided by the decision unit; and
an output unit that outputs, by a voice or text, the first sentence generated by the first generation unit and the second sentence generated by the second generation unit.

12. An interaction method of using a processor to interact with a user by a voice or text,
the processor being configured to:
decide a policy for a response content to a prompt which is input by the user;
generate a first sentence based on the policy decided;
generate a second sentence based on the policy decided; and
output, by a voice or text, the first sentence generated and the second sentence generated.

13. An interaction system that interacts with a user by a voice or text, the interaction system comprising:
a decision unit that decides a policy for a response content to a prompt which is input by the user;
a first generation unit that generates a first sentence based on the policy decided by the decision unit;
a second generation unit that generates a second sentence based on the policy decided by the decision unit; and
an output unit that outputs, by a voice or text, the first sentence generated by the first generation unit and the second sentence generated by the second generation unit.
